(19) United States
(12) Patent Application Publication
(10) Pub. No.: US 2023/0247732 A1
(43) Pub. Date: Aug. 3, 2023

(54) HEATING DEVICE FOR HEATING CLOTHING, WIRE STRIP BODY, AND HEATING CLOTHING

(71) Applicant: SHENZHEN KUSEN TECHNOLOGY TRADING CO., LTD., SHENZHEN (CN)

(72) Inventor: ER JUN CHE, SHENZHEN (CN)

(21) Appl. No.: 17/707,994

(22) Filed: Mar. 30, 2022

(30) Foreign Application Priority Data
Jan. 28, 2022 (CN) 202220240967.7

(51) Int. Cl. H05B 3/34

(52) U.S. Cl. CPC H05B 3/342

(57) ABSTRACT

A heating device for heating clothing and a heating clothing include a controller, wires, wire carriers, and heating sheets. Each of the wires is electrically connected to the controller and corresponding heating sheets. The controller is configured to control the heating device. at least a part of the wires are arranged on the wire carriers. the part of the wires arranged on the wire carriers are in a bent shape. When the wires are pulled, the part of the wires on the wire carriers that are in a bent shape provide extra stretched length to avoid pulling on connection between the wires, the controller, and the heating sheets. Meanwhile, the wire carriers share pulling force and reduce pulling on the wires. Thus, the wires are not easily pulled, and a problem of poor electrical connection is avoided.

### TECHNICAL FIELD

The present disclosure relates to a field of heating clothing, and in particular to a heating device for heating clothing, a wire strip body, and a heating clothing.

### BACKGROUND

Heating clothing is clothing in which a heating device is provided. The heating device in the heating clothing provides heat to a wearer and helps the wearer keep out the cold. Because of the need to generate heat, the heating device necessarily needs wires.

During wearing and use of the heating clothing, the heating device is inevitably pulled, and the wires of the heating device are easily pulled, resulting in a poor electrical connection.

### SUMMARY

A purpose of the present disclosure is to provide a heating device for heating clothing, a wire strip body, and a heating clothing. Wires of the heating device are not easily pulled, and poor electrical connection is avoided.

The present disclosure provides a heating device for heating clothing. The heating device comprises a controller, wires, wire carriers, and heating sheets. Each of the wires is electrically connected to the controller and corresponding heating sheets. The controller is configured to control the heating device. at least a part of the wires are arranged on the wire carriers. the part of the wires arranged on the wire carriers are in a bent shape.

Optionally, the wire carriers are elastic stretch strips.

Optionally, the part of the wires arranged on the wire carriers extend in the bent shape along a longitudinal direction of the wire carriers.

Optionally, the wires comprise first wires and second wires. Each of the first wires and a corresponding second wire are arranged side by side on corresponding wire carriers. The wire carriers comprise a plurality of fixing portions. The first wires and the second wires are fixed on the wire carriers through the plurality of fixing portions.

Optionally, each of the first wires and the corresponding second wire are extended in a wave shape on the corresponding wire carriers. The first wires and the second wires comprise arc-shaped bending sections and straight connecting sections. Each of the straight connecting sections is connected with two adjacent arc-shaped bending sections. The fixing portions are fixed on the straight connecting sections.

Optionally, ends of the wires and ends of the wire carriers are embedded and fixed inside the heating sheets.

Optionally, at least two heating sheets are provided. The wires and the wire carriers are electrically connected to the heating sheets in sequence.

Optionally, a first heating position control module, a second heating position control module, and a third heating position control module are integrated in the controller. The first heating position control module, the second heating position control module, and the third heating position control module separately control heating of different heating sheets.

Optionally, an initial power enhancing module is integrated in the controller. The initial power enhancing module is configured to increase a power of the heating device to accelerate heating of the heating sheets in an initial startup stage of the heating device.

Optionally, the heating device further comprises a power connector; the power connector is electrically connected with the controller. The power connector is configured to connect with an external power supply and provides power for the heating device.

Optionally, each of the heating sheets comprises a covering sheet and a heating component. Each heating component is connected with a corresponding wire, and each covering sheet covers one end of a corresponding wire, one end of a corresponding wire carrier, and a corresponding heating component.

The present disclosure further discloses a wire strip body. The wire strip body comprises a wire and a wire carrier. at least a part of the wire is arranged on the wire carrier. the part of the wire arranged on the wire carrier is in a bent shape.

Optionally, the wire carrier is an elastic stretch strip.

Optionally, the part of the wire arranged on the wire carrier extends in the bent shape along a longitudinal direction of the wire carrier.

Optionally, the wire comprises a first wire and a second wire. The first wire and the second wire are arranged side by side on the wire carrier. The wire carrier comprises a plurality of fixing portions. The first wire and the second wire are fixed on the wire carrier through the plurality of fixing portions.

Optionally, the first wire and the second wire are extended in a wave shape on the wire carrier. The first wire and the second wire comprise arc-shaped bending sections and straight connecting sections. Each of the straight connecting sections is connected with two adjacent arc-shaped bending sections. The fixing portions are fixed on the straight connecting sections.

The present disclosure further discloses a heating clothing. The heating clothing comprises the heating device mentioned above.

In the heating device of the present disclosure, the part of the wires are arranged on the wire carriers, and the part of the wires arranged on the wire carriers are arranged in the bent shape. When the wires are pulled, the part of the wires on the wire carriers that are in the bent shape provide extra stretched length to avoid pulling on connection between the wires, the controller, and the heating sheets. Meanwhile, the wire carriers share pulling force and reduce pulling on the wires. Thus, the wires are not easily pulled, and the problem of poor electrical connection is avoided.

### BRIEF DESCRIPTION OF DRAWINGS

The drawings are included to provide a further understanding of embodiments of the present disclosure, which form portions of the specification and are used to illustrate implementation manners of the present disclosure and are intended to illustrate operating principles of the present disclosure together with the description. Apparently, the drawings in the following description are merely some of the embodiments of the present disclosure, and those skilled in the art are able to obtain other drawings according to the drawings without contributing any inventive labor. In the drawing:

FIG. 1 is a schematic diagram of a heating device according to one embodiment of the present disclosure.

FIG. 2 is another schematic diagram of the heating device according to one embodiment of the present disclosure.

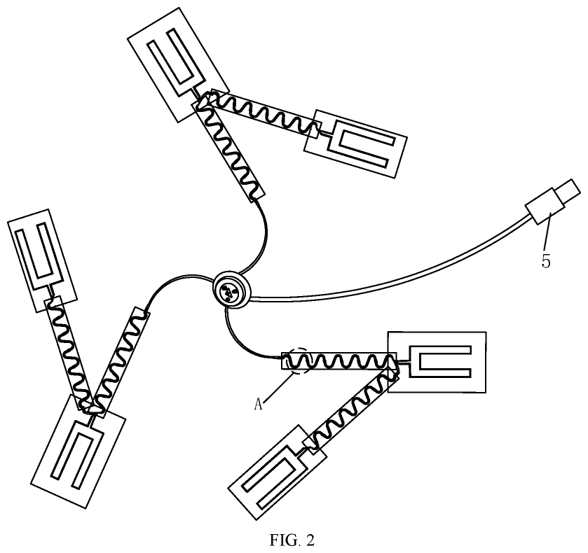

FIG. 3 is an enlarged view of portion A shown in FIG. 2.

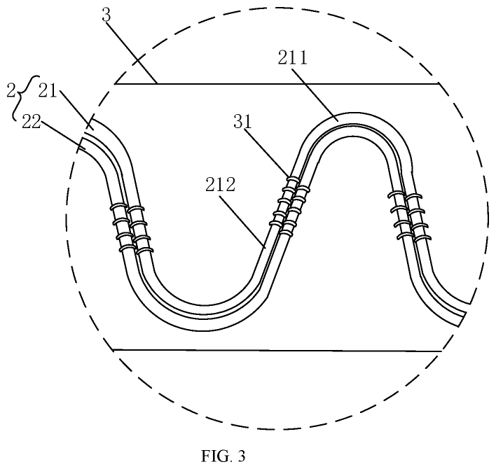

FIG. 4 is a schematic diagram of a wire strip body according to one embodiment of the present disclosure.

In the drawings:

1—controller; 11—first heating position control module; 12—second heating position control module; 13—third heating position control module; 2—wire; 21—first wire; 211—arc-shaped bending section; 212—straight connecting section; 22—second wire; 3—wire carrier; 31—fixing portion; 4—heating sheet; 41—covering sheet; 42—heating component; 5—power connector.

### DETAILED DESCRIPTION

It should be understood that specific structure and function details disclosed herein are only representative and are used for the purpose of describing exemplary embodiments of the present disclosure. However, the present disclosure may be achieved in many alternative forms and shall not be interpreted to be only limited to the embodiments described herein.

The present disclosure will be described in detail below with reference to the accompanying drawings and optional embodiments.

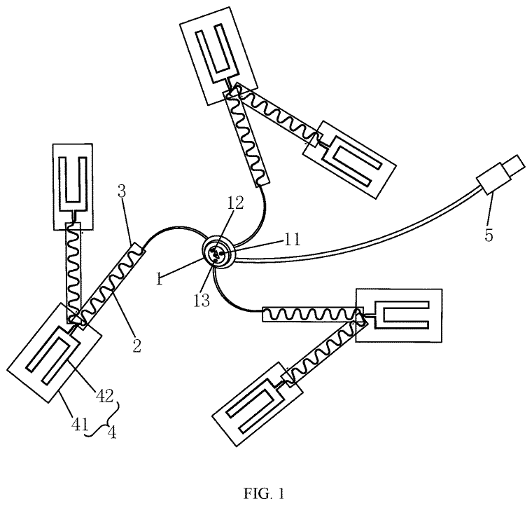

As shown in FIG. 1, the present disclosure provides a heating device for heating clothing. The heating device comprises: a controller 1, wires 2, wire carriers 3, and heating sheets 4. Each of the wires 2 is electrically connected to the controller 1 and corresponding heating sheets 4. The controller 1 is configured to control the heating device. at least a part of the wires 2 are arranged on the wire carriers 3. the part of the wires 2 arranged on the wire carriers 3 are in a bent shape.

In the heating device of the present disclosure, the part of the wires 2 are arranged on the wire carriers 3, and the part of the wires 2 arranged on the wire carriers 3 are arranged in the bent shape. When the wires 2 are pulled, the part of the wires 2 on the wire carriers 3 that are in the bent shape provide extra stretched length to avoid pulling on the connection between the wires 2, the controller 1, and the heating sheets 4. Meanwhile, the wire carriers 3 share pulling force and reduce pulling on the wires 2. Thus, the wires 2 are not easily pulled, and a problem of poor electrical connection is avoided.

Optionally, the controller 1 is configured to control startup, shutdown, a heating power, heating positions, and etc. of the heating device.

Optionally, the wire carriers 3 are elastic stretch strips. In the embodiment, the wire carriers 3 are elastic stretch strips that are stretchable when pulled. the part of the wires 2 that are bent are stretched along with the elastic stretch strips, so as to avoid pulling on the connection between the wires 2, the controller 1, and the heating sheets 4. Meanwhile, the elastic stretch strips have a good effect of sharing the pulling force.

Optionally, the part of the wires 2 arranged on the wire carriers extend in the bent shape along a longitudinal direction of the wire carriers 3. In the embodiment, the part of the wires 2 arranged on the wire carriers 3 extend in the bent shape along the longitudinal direction of the wire carriers, so when the wires 2 are pulled, an adaptive extension effect of the wires 2 is good.

Optionally, the wires 2 comprise first wires 21 and second wires 22. Each of the first wires 21 and a corresponding second wire 22 are arranged side by side on corresponding wire carriers 3. The wire carriers 3 comprise a plurality of fixing portions 31. The first wires 21 and the second wires 22 are fixed on the wire carriers 3 through the plurality of fixing portions 31. In the embodiment, the first wires 21 and the second wires 22 are separately fixed on the wire carriers 3 through the plurality of fixing portions 31. The first wires 21 and the second wires 22 are fixed separately, so fixing effect of first wires 21 and the second wires 22 is good and reset effect of the first wires 21 and the second wires 22 after stretching is relatively good. Moreover, the first wires 21 and the second wires 22 are fixed by the fixing portions 31, positioning effects of the first wires 21 and the second wires 22 are relatively goof. Further, the first wires 21 and the second wires 22 are not easily displaced or deformed even after repeated stretching.

Optionally, each of the first wires 21 and the corresponding second wire 22 are extended in a wave shape on the corresponding wire carriers 3. The first wires 21 and the second wires 22 comprise arc-shaped bending sections 211 and straight connecting sections 212. Each of the straight connecting sections 212 is connected with two adjacent arc-shaped bending sections 211. The fixing portions 31 are fixed on the straight connecting sections 212. The straight connecting sections 212 are positions of the wires that deform or move less during a stretching process. In the embodiment, the fixing portions 31 are arranged on the straight connecting sections 212, so the fixing portions 31 are not easy to loosen. A direction of the first wires 21 and a direction of the second wires 22 are not easily displaced and the first wires 21 and the second wires 22 are prevented from deforming. Further, the fixing portions 31 do not affect deformation of the arc-shaped bending sections 211. In the embodiment, the fixing portion 31 may be yarns, which is not limited thereto.

Optionally, ends of the wires 2 and ends of the wire carriers 3 are embedded and fixed inside the heating sheets 4. In the embodiment. one end of each of the wire carriers 3 is embedded and fixed inside a corresponding heating sheet 4, so each of the heating sheets 4 fixes a corresponding wire carrier 3 and a corresponding wire 2. The electrical connection between the wires 2 and the heating sheets 4 is not prone to poor electrical connection. Specifically, each of the heating sheets 4 comprises a covering sheet 41 and a heating component 42. Each heating component 42 is connected with a corresponding wire 2, and each covering sheet 41 covers one end of a corresponding wire 2, one end of a corresponding wire carrier 3, and a corresponding heating component 42. In the embodiment, each covering sheet 41 fixes the connection between the corresponding heating component 42 and the corresponding wire 2. Specifically, the heating components 42 may be graphene heating wires.

Optionally, at least two heating sheets 4 are provided. The wires and the wire carriers are electrically connected to the heating sheets 4 in sequence. In the embodiment, the wires 2 and the wire carriers 3 are electrically connected to the heating sheets 4 in sequence, which saves the wires 2 and reduces shunt of the wires 2.

Optionally, a first heating position control module 11, a second heating position control module 12, and a third heating position control module 13 are integrated in the controller 1. The first heating position control module 11, the second heating position control module 12, and the third heating position control module 13 separately control heating of different heating sheets 4. In the embodiment, since the first heating position control module 11, the second heating position control module 12, and the third heating position control module 13 separately control the heating of different heating sheets 4, so that heating of different portions of the heating clothing is realized and control of the heating clothing is flexible. For example, the first heating position control module 11 controls the heating sheets 4 arranged in a position of the heating clothing corresponding to the back of a human body to generate heat, the second heating position control module 12 controls the heating sheets 4 arranged in a position of the heating clothing corresponding to the chest and abdomen of the human body to generate heat, and the third heating position control module 13 controls the heating sheets 4 arranged in a collar or a hat of the heating clothing to generate heat.

Optionally, an initial power enhancing module (not shown in the drawings) is integrated in the controller 1. The initial power enhancing module is configured to increase a power of the heating device to accelerate heating of the heating sheets 4 in an initial startup stage of the heating device.

In the embodiment, through control of the initial power enhancing module, the power of the heating device is relatively high in the initial startup stage, and a heating speed of the heating sheets 4 is fast. For example, the power of the heating device is increased within a certain period of time when the heating device is turned on, such as within 10 seconds, within 30 seconds, and within 60 seconds. After the time is up, the power of the heating device returns to normal.

Optionally, the heating device further comprises a power connector 5. The power connector 5 is electrically connected with the controller 1. The power connector 5 is configured to connect with an external power supply and provides power for the heating device. The power connector 5 is convenient to connect with the external power supply. Specifically, the power connector 5 may be a USB connector or the like.

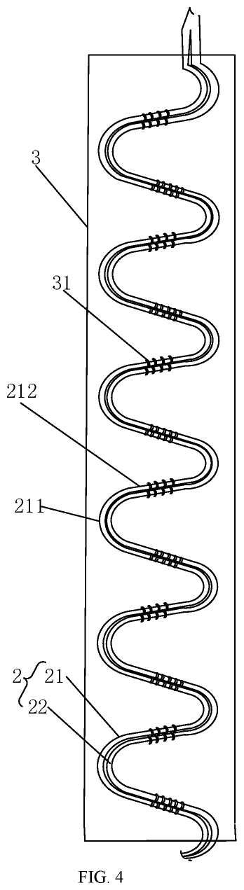

As shown in FIG. 4, the present disclosure further discloses a wire strip body. The wire strip body comprises a wire 2 and a wire carrier 3. at least a part of the wire 2 is arranged on the wire carrier 3. the part of the wire 2 arranged on the wire carrier 3 is in a bent shape.

In the wire strip body of the present disclosure, the part of the wire 2 is arranged on the wire carrier 3, and the part of the wires 2 arranged on the wire carrier 3 is arranged in the bent shape. When the wire 2 is pulled, the part of the wire 2 on the wire carrier 3 that is bent provide extra stretched length to avoid pulling on the wire 2. Meanwhile, the wire carrier 3 shares pulling force and reduces pulling on the wire 2. Thus, pulling force received by the wire 2 is small, and the problem of poor electrical connection is not easy to occur when the wire strip body is applied to the heating device of the present disclosure, the heating clothing of the present disclosure, or other products.

Optionally, the wire carrier 3 is an elastic stretch strip. In the embodiment, the wire carriers 3 is the elastic stretch strip that is stretchable when pulled. the part of the wire 2 that is in the bent shape is stretched along with the elastic stretch strip, so as to avoid pulling on the wire 2 and avoid poor electrical connection of the wire 2. Meanwhile, the elastic stretch strip has a good effect of sharing the pulling force.

Optionally, the part of the wire arranged on the wire carrier extends in the bent shape along a longitudinal direction of the wire carrier 3. In the embodiment, the part of the wire 2 arranged on the wire carrier 3 extends in the bent shape along the longitudinal direction of the wire carriers, so when the wire 2 is pulled, an adaptive extension effect of the wire 2 is good.

Optionally, the wire 2 comprises a first wire 21 and a second wire 22. The first wire and the second wire are arranged side by side on the wire carrier 3. The wire carrier 3 comprises a plurality of fixing portions 31. The first wire 21 and the second wire 22 are fixed on the wire carrier 3 through the plurality of fixing portions 31. In the embodiment, the first wire 21 and the second wire 22 are separately fixed on the wire carrier 3 through the plurality of fixing portions 31. The first wire 21 and the second wire 22 are fixed separately, so fixing effect of the first wire 21 and the second wire 22 is good and reset effect of the first wire 21 and the second wire 22 after stretching is relatively good. Moreover, the first wire 21 and the second wire 22 are fixed by the fixing portions 31, positioning effects of the first wire 21 and the second wire 22 are relatively goof. Further, the first wire 21 and the second wire 22 are not easily displaced or deformed even after repeated stretching.

Optionally, the first wire 21 and the second wire 22 are extended in a wave shape on the wire carrier 3. The first wire 21 and the second wire 22 comprise arc-shaped bending sections 211 and straight connecting sections 212. Each of the straight connecting sections 212 is connected with two adjacent arc-shaped bending sections 211. The fixing portions 31 are fixed on the straight connecting sections 212. The straight connecting sections 212 are positions that deform or move less during a stretching process. In the embodiment, the fixing portions 31 are arranged on the straight connecting sections 212, so the fixing portions 31 are not easy to loosen. A direction of the first wires 21 and the second wires 22 is not easily displaced and the first wires 21 and the second wires 22 are prevented from deforming. Further, the fixing portions 31 do not affect deformation of the arc-shaped bending sections 211. In the embodiment, the fixing portion 31 may be yarns, which is not limited thereto.

In another embodiment, the present disclosure further discloses a heating clothing. The heating clothing comprises the heating device or the wire strip body mentioned above.

The above content is a further detailed description of the present disclosure in combination with specific optional embodiments, and specific implementations of the present disclosure are not considered to be limited by these descriptions. For those of ordinary skill in the technical field of the present disclosure, without departing from the concept of the present disclosure, some simple deductions or substitutions can be made, which should be regarded as fall within the protection scope of the present disclosure.

What is claimed is:

1. A heating device for heating clothing, comprising: a controller, wires, wire carriers, and heating sheets; wherein each of the wires is electrically connected to the controller and corresponding heating sheets; the controller is configured to control the heating device; at least a part of the wires are arranged on the wire carriers; the part of the wires arranged on the wire carriers are in a bent shape.

2. The heating device according to claim 1, wherein the wire carriers are elastic stretch strips.

3. The heating device according to claim 1, wherein the part of the wires arranged on the wire carriers extend in the bent shape along a longitudinal direction of the wire carriers.

4. The heating device according to claim 2, wherein the part of the wires arranged on the wire carriers extend in the bent shape along a longitudinal direction of the wire carriers.

5. The heating device according to claim 4, wherein the wires comprise first wires and second wires, each of the first wires and a corresponding second wire are arranged side by side on corresponding wire carriers; the wire carriers comprise a plurality of fixing portions; the first wires and the second wires are fixed on the wire carriers through the plurality of fixing portions.

6. The heating device according to claim 5, wherein each of the first wires and the corresponding second wire are extended in a wave shape on the corresponding wire carriers; the first wires and the second wires comprise arc-shaped bending sections and straight connecting sections; each of the straight connecting sections is connected with two adjacent arc-shaped bending sections; the fixing portions are fixed on the straight connecting sections.

7. The heating device according to claim 2, wherein ends of the wires and ends of the wire carriers are embedded and fixed inside the heating sheets.

8. The heating device according to claim 2, wherein at least two heating sheets are provided; the wires and the wire carriers are electrically connected to the heating sheets in sequence.

9. The heating device according to claim 1, wherein a first heating position control module, a second heating position control module, and a third heating position control module are integrated in the controller; the first heating position control module, the second heating position control module, and the third heating position control module separately control heating of different heating sheets.

10. The heating device according to claim 9, wherein an initial power enhancing module is integrated in the controller; the initial power enhancing module is configured to increase a power of the heating device to accelerate heating of the heating sheets in an initial startup stage of the heating device.

11. The heating device according to claim 1, wherein the heating device further comprises a power connector; the power connector is electrically connected with the controller; the power connector is configured to connect with an external power supply and provides power for the heating device.

12. The heating device according to claim 7, wherein each of the heating sheets comprises a covering sheet and a heating component; each heating component is connected with a corresponding wire; each covering sheet covers one end of a corresponding wire, one end of a corresponding wire carrier, and a corresponding heating component.

13. A wire strip body, comprising: a wire and a wire carrier; at least a part of the wire is arranged on the wire carrier; the part of the wire arranged on the wire carrier is in a bent shape.

14. The wire strip body according to claim 13, wherein the wire carrier is an elastic stretch strip.

15. The wire strip body according to claim 13, wherein the part of the wire arranged on the wire carrier extends in the bent shape along a longitudinal direction of the wire carrier.

16. The wire strip body according to claim 14, wherein the part of the wire arranged on the wire carrier extends in the bent shape along a longitudinal direction of the wire carrier.

17. The wire strip body according to claim 16, wherein the wire comprises a first wire and a second wire; the first wire and the second wire are arranged side by side on the wire carrier; the wire carrier comprises a plurality of fixing portions; the first wire and the second wire are fixed on the wire carrier through the plurality of fixing portions.

18. The wire strip body according to claim 17, wherein the first wire and the second wire are extended in a wave shape on the wire carrier; the first wire and the second wire comprise arc-shaped bending sections and straight connecting sections; each of the straight connecting sections is connected with two adjacent arc-shaped bending sections; the fixing portions are fixed on the straight connecting sections.

19. A heating clothing, comprising: a plurality of the wire strip body according to claim 13.

20. The heating clothing according to claim 19. wherein the heating clothing further comprises a heating device; the heating device comprises a controller and heating sheets; each of the wires is electrically connected to the controller and corresponding heating sheets; the controller is configured to control the heating device.
